(19) United States
(12) Patent Application Publication
(10) Pub. No.: US 2013/0118849 A1
(43) Pub. Date: May 16, 2013

(54) INERTIA INCREMENTAL APPARATUS FOR FLYWHEEL OF ENGINE

(71) Applicants: Jae Woong Hwang, Yongin-si (KR); Yong Wook Jin, Suwon-si (KR); Wan Soo Oh, Yongin-si (KR)

(72) Inventors: Jae Woong Hwang, Yongin-si (KR); Yong Wook Jin, Suwon-si (KR); Wan Soo Oh, Yongin-si (KR)

(73) Assignee: Hyundai Motor Company, Seoul (KR)

(21) Appl. No.: 13/605,522

(22) Filed: Sep. 6, 2012

(30) Foreign Application Priority Data
Nov. 11, 2011 (KR) 10-2011-0117521

(51) Int. Cl. H02K 7/02

(52) U.S. Cl. 192/3.52; 74/572.11

(57) ABSTRACT

An inertia incremental apparatus for a flywheel of an engine is provided to improve NVH performance of a vehicle driving system as well as rotary vibration generated from a crankshaft of the engine by remarkably increasing inertial force of the flywheel of the engine while occupying a relatively small volume and a relatively small weight to assure quiet and safe operability and ride comfort of a vehicle.

### CROSS-REFERENCE TO RELATED APPLICATION

The present application claims priority of Korean Patent Application Number 10-2011-0117521 filed Nov. 11, 2011, the entire contents of which application is incorporated herein for all purposes by this reference.

### BACKGROUND OF INVENTION

1. Field of Invention

The present invention relates to a technology that can increase inertia of a flywheel of an engine, and more particularly, to a technology that can effectively increase inertia of a flywheel without increasing an occupied volume.

2. Description of Related Art

An engine rotates a crankshaft with power generated in an explosion stroke and since the explosion stroke is not continuous, a twist vibration is generated in the crankshaft by a discontinuous power stroke and since a rotary vibration is not preferable in continuous driving of a vehicle, a flywheel providing relatively great rotary inertia is mounted on the crankshaft, thereby alleviating or reducing the rotary vibration caused due to an operation of the engine.

Therefore, only in terms of the rotary vibration and NVH of a vehicle driving system, it is advantageous as inertial force of the flywheel is greater and the inertial force of the flywheel tends to increasing according to a weight and a volume of the flywheel, and as a result, the size of the weight of the flywheel needs to increase as possible, but there is a limit to increase inertia by increasing the weight and the volume of the flywheel considering a relationship between the weight and fuel efficiency of a vehicle and mountability.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention provide for an inertia incremental apparatus for a flywheel of an engine that can not only remarkably improve NVH performance of a vehicle driving system but also solve rotary vibration generated from a crankshaft of the engine by remarkably increasing inertial force of the flywheel of the engine while occupying a relatively small volume and a relatively small weight to assure quiet and safe operability and ride comfort of a vehicle.

Various aspects of the present invention provide for an inertia incremental apparatus for a flywheel of an engine, including: a drive plate integrally connected to a crankshaft of the engine; a flywheel installed to be relatively rotatable to the crankshaft; and an acceleration mechanism configured to accelerate rotary force of the drive plate and transmit the increased rotary force to the flywheel.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a diagram illustrating a configuration of an exemplary inertia incremental apparatus for a flywheel of an engine according to the present invention.

FIG. 2 is a diagram illustrating a planet gear device of FIG. 1.

It should be understood that the appended drawings are not necessarily to scale, presenting a somewhat simplified representation of various preferred features illustrative of the basic principles of the invention.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

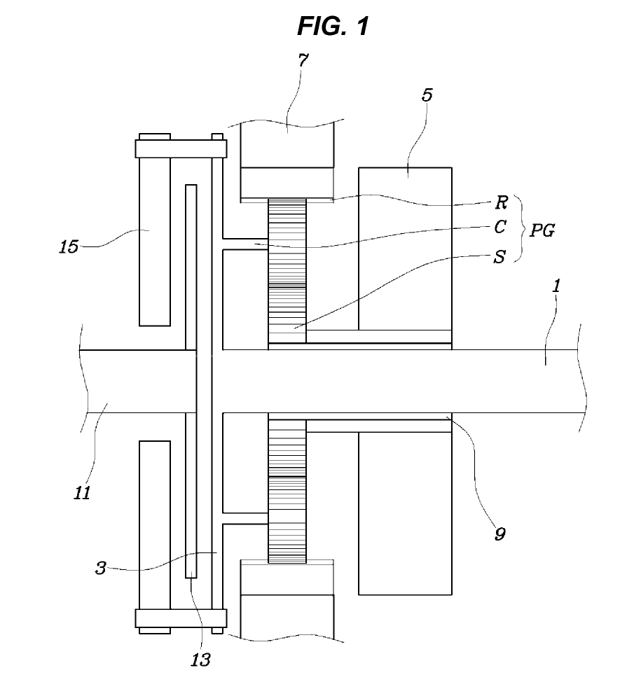

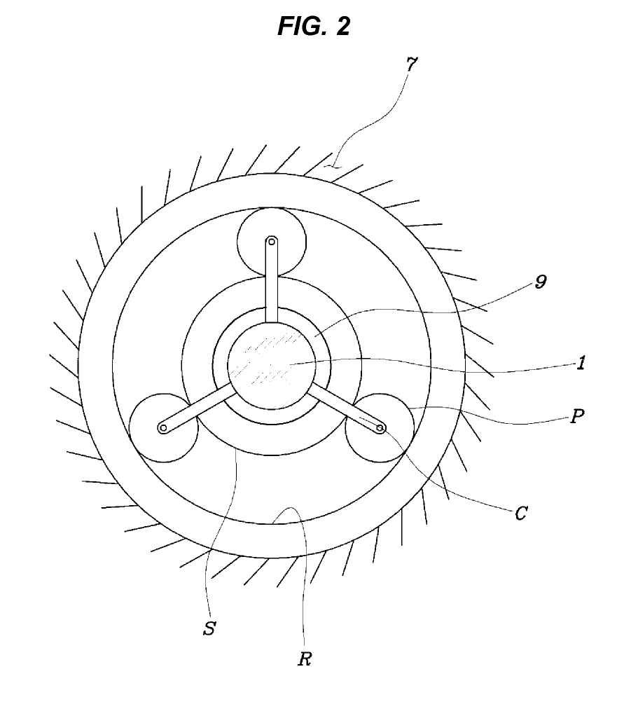

Referring to FIGS. 1 and 2, an inertia incremental apparatus for a flywheel of an engine according to various embodiments of the present invention includes a drive plate 3 integrally connected to a crankshaft 1 of the engine, a flywheel 5 installed to be relatively rotatable to the crankshaft 1, and an acceleration mechanism configured to accelerate rotary force of the drive plate 3 and transmit the increased rotary force to the flywheel 5. One will appreciate that in various embodiments the drive plate may be monolithically formed with the crankshaft.

That is, unlike priorart, the flywheel 5 is separated from the crankshaft 1 and supported to be relatively rotatable on the crankshaft 1 and the rotary force of the crankshaft 1 is transmitted to the flywheel 5 through the acceleration mechanism, and as a result, inertia of the flywheel 5 increases according to an acceleration ratio to act on the crankshaft, thereby providing greater inertia to the crankshaft 1 with relatively small volume and weight.

In various embodiments, the acceleration mechanism may be configured with a planetary gear device PG including a plurality of rotary elements and each of the drive plate 3 and the flywheel 5 is separately connected to the rotary elements of the planetary gear device PG.

That is the planetary gear device PG is configured by a single pinion simple planetary gear including a sun gear S and a carrier C, and a ring gear R as the rotary elements and the drive plate 3 is connected to the carrier C, the flywheel 5 is connected to the sun gear S, and the ring gear R is fixed to the inside of a transmission case 7 with rotation constrained.

Accordingly, the rotary force from the crankshaft 1 is transmitted to the carrier C through the drive plate 3 and the rotary force of the carrier C is accelerated and transmitted to the sun gear S as the ring gear R is fixed, and as a result, the flywheel 5 is accelerated and rotated.

Meanwhile, the flywheel 5 and the sun gear S are integrally connected to each other and the openings of the flywheels 5 and the sun gear S are supported on the crankshaft 1 through a bearing 9. One will appreciate that in various embodiments, the flywheel and the sun gear may be monolithically formed.

Of course, the bearing 9 may be substituted by a bush inserted into the openings of the flywheel 5 and the sun gear S.

The flywheel 5 is placed at the engine side based on the drive plate 3, the planetary gear device PG is placed between the flywheel 5 and the drive plate 3, and the drive plate 3 forms a clutch together with a clutch disk 13 installed on a transmission input shaft 11.

That is, a clutch cover 15 is mounted on the drive plate 3 and the clutch disk 13 connected to the transmission input shaft 11 and forming the clutch together with the drive plate 3 is installed in a space between the clutch cover 15 and the drive plate 3.

The clutch disk is installed to correspond to the flywheel integrally mounted on the crankshaft to form a clutch that controls power transmitted to the transmission in the related art, but in the present invention, the clutch disk 13 is installed to correspond to the drive plate 3 to configure the clutch and the flywheel 5 is placed at the engine side to be accelerated to the planetary gear device PG, and as a result, the flywheel 5 may rotate at different rotary speed from the crankshaft 1.

As compared with the simple flywheel in the related art which has the volumes and weights occupied by the flywheel 5 and the planetary gear device PG is integrally fixed to the crankshaft, in the inertia incremental apparatus for the flywheel of the engine configured as above, while the flywheel 5 is accelerated and rotated faster than the crankshaft 1 by an acceleration ratio formed by the planetary gear device PG, inertia provided by reaction force thereto is remarkably great, and as a result, rotary inertia required for the crankshaft 1 can be maximized while the increase in volume and weight of the flywheel 5 is suppressed.

Of course, the rotary inertia increased as above attenuates rotary vibration of the crankshaft 1 and significantly improves NVH performance of a vehicle driving system to assure quiet and safe operability and ride comfort of a vehicle.

Meanwhile, as the flywheel, a dual mass flywheel (DMF) may be used as well as the general flywheel configured by a single mass body of FIG. 1. In this case, more improved NVH performance can be achieved.

According to various embodiments of the present invention, there is provided an inertia incremental apparatus for a flywheel of an engine that can remarkably improve NVH performance of a vehicle driving system as well as rotary vibration generated from a crankshaft of the engine by remarkably increasing inertial force of the flywheel of the engine while occupying a relatively small volume and a relatively small weight to assure quiet and safe operability and ride comfort of a vehicle.

For convenience in explanation and accurate definition in the appended claims, the terms upper or lower, front or rear, inside or outside, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An inertia incremental apparatus for a flywheel of an engine, comprising:
a drive plate integrally connected to a crankshaft of the engine;
a flywheel relatively rotatable to the crankshaft; and
an acceleration mechanism configured to accelerate rotary force of the drive plate and transmit the increased rotary force to the flywheel.

2. The inertia incremental apparatus of claim 1, wherein the acceleration mechanism includes a planetary gear device with a plurality of rotary elements, and each of the drive plate and the flywheel is separately connected to the rotary elements of the planetary gear device.

3. The inertia incremental apparatus of claim 2, wherein the planetary gear device includes a single pinion simple planetary gear with a sun gear, a carrier and a ring gear as the rotary elements, and the drive plate is connected to the carrier, the flywheel is connected to the sun gear, and the ring gear is fixed to the inside of a transmission case with rotation constrained.

4. The inertia incremental apparatus of claim 3, wherein the flywheel and the sun gear are integrally connected to each other, and wherein an opening in the flywheel and an opening in the sun gear are supported on the crankshaft by a bearing.

5. The inertia incremental apparatus of claim 1, wherein the flywheel is placed at an engine side based on the drive plate, the planetary gear device is placed between the flywheel and the drive plate, and the drive plate forms a clutch together with a clutch disk installed on a transmission input shaft.

6. The inertia incremental apparatus of claim 1, wherein a clutch cover is mounted on the drive plate and the clutch disk connected to the transmission input shaft to form the clutch together with the drive plate is installed in a space between the clutch cover and the drive plate.

7. The inertia incremental apparatus of claims 1, wherein the flywheel is configured by a dual mass flywheel.
